(19) United States
(12) Patent Application Publication
(10) Pub. No.: US 2025/0165965 A1
(43) Pub. Date: May 22, 2025

(54) OFFLINE PAYMENT SYSTEM AND MANAGEMENT METHOD THEREFOR

(71) Applicant: paymentinapp Inc., Seoul (KR)

(72) Inventor: Junghyung Suh, Seoul (KR)

(21) Appl. No.: 18/537,767

(22) Filed: Dec. 12, 2023

(30) Foreign Application Priority Data
Nov. 22, 2023 (KR) 10-2023-0163805

(51) Int. Cl. G06Q 20/38; G06Q 20/22; G06Q 20/40

(52) U.S. Cl. CPC G06Q 20/387; G06Q 20/227; G06Q 20/40

(57) ABSTRACT

An offline payment system comprises: a medium recognition unit recognizing a payment medium; a data management unit storing a control file including whether multiple payment media are available based on an active list in connection with a payment medium issuance company; and an approval processing unit processing whether to approve the recognized payment medium by referring to the control file stored in the data management unit.

### CROSS-REFERENCE TO RELATED APPLICATION

This application claims priority under 35 U.S.C. § 119 (a) to Korean Patent Application No. 10-2023-0163805 filed in the Korean Intellectual Property Office on Nov. 22, 2023, which is incorporated herein by reference in its entirety.

### BACKGROUND

### (a) Technical Field

The present disclosure relates to an offline payment system and a management method therefor.

### (b) Background Art

An offline payment is a scheme in which a card terminal checks only a few requirements for a card requested for payment, and then performs approval instead of requesting approval for a payment amount to a card company server.

A payment medium such as the card is granted with multiple numbers, and has a unique system according to a card company.

In general, the numbers granted to the card may include a Bank Identification Number (BIN) of a card company, a serial number (Primary No.) granted to a card product, and a number (Check sum) for identifying the validity of the card.

The offline payment includes a Deny control scheme and a Positive control scheme.

The Deny control scheme judges the validity of the card while managing a black list or a deny list.

For the Deny control scheme, in a card payment terminal, a storage space for one card is set to 7 bytes, and only card numbers (hereinafter, referred to as the black list) to be controlled are stored.

In the Deny control scheme, the card number is sequentially stored based on BIN of the card company, it is checked whether there is the card number in a black list table upon reading the card, and if the card number is in the black list, the card is denied, otherwise, the card is processed as normal.

Meanwhile, for the Positive control scheme, in a card payment terminal, a storage space for one card is set to 1 bit, and all card numbers are stored.

In the Positive control scheme, Alias number which is a virtual identification number corresponding to the card number is read and converted into an absolute address (Bitmap index), and for example, if a value of a bit is 1, the card is processed to be available and if the value of the bit is 0, the card is processed to be unavailable.

However, the existing control scheme has a problem in that as the number of cards increases, a lot of storage space for a payment system is required, and a processing speed is delayed. In addition, there is a limit in accommodating discount information according to concession and events.

### SUMMARY OF THE DISCLOSURE

In order to solve the problems in the related art, the present disclosure has been made in an effort to provide an offline payment system and a management method therefor, which can efficiently store and manage information on various payment media, and increase data storage efficiency.

In order to achieve the objects, according to an embodiment of the present disclosure, provided is an offline payment system including: a medium recognition unit recognizing a payment medium; a data management unit storing a control file including whether multiple payment media are available based on an active list in connection with a payment medium issuance company; and an approval processing unit processing whether to approve the recognized payment medium by referring to the control file stored in the data management unit.

The data management unit may generate multiple upper folders having different first unique numbers according to individual attributes including whether each of the multiple payment media is available, whether a concession discount is made, whether automatic charging is made, and whether an event discount is made, and store multiple files having a second unique number capable of identifying a payment medium issuance company in each of the multiple upper folders.

The data management unit may compress and store information for identifying an action attribute value for each of whether each of multiple payment media issued by a first payment medium issuance company is available, whether a concession discount is made, whether automatic charging is made, and whether a discount is made in each of the multiple files.

The data management unit may grant bits for identifying the action attribute value in a predetermined serial number order of the multiple payment media issued by the first payment medium issuance company, convert the granted bits into a text by using a binary-text conversion technique, and compress and store the converted text.

The data management unit may convert bits corresponding to multiple bytes into one text by using ASCII (American Standard Code for Information Interchange), UTF-16 ((16-bit Unicode Transformation Format), and Base64.

When booting the offline payment system, an array name including the first unique number and the second unique number may be generated and loaded to a memory.

A valid period for the action attribute value of each of the multiple payment media may be set, and a server connected through a network may change the action attribute value of each of the multiple payment media by referring to the valid period.

The control file may be generated for each of different versions according to a period, and the data communication unit may search for a version of a control file currently stored, and a version of a control file to be downloaded, and then receive a control file corresponding to the searched version from the server.

The offline payment system may further include an approval history storage unit hashing and storing No. of the payment medium when approving the recognized payment medium.

The approval history storage unit may convert a payment medium issuance company unique number of the recognized payment medium into a virtual number by using one of multiple matching tables, and store a number acquired by hashing the converted virtual number and the remaining serial number of the payment medium as a hashed primary account number (PAN) of the payment medium.

According to another embodiment of the present disclosure, provided is a management method of an offline payment system, including the steps of: storing a control file including whether multiple payment media are available based on an active list in connection with a payment medium issuance company; recognizing a payment medium; and processing whether to approve the recognized payment medium by referring to the stored control file.

According to still another embodiment of the present disclosure, provided is a computer program storing a computer-readable storage medium performing the method.

According to the present disclosure, there is an advantage in that a control file is stored as a CIN file name in an action folder, and compressed to efficiently store a payment medium number and control related information thereof.

Further, according to the present disclosure, there is an advantage in that efficient download of the control file is enabled, and efficient encryption of PAN can be performed.

### BRIEF DESCRIPTION OF THE DRAWINGS

FIG. 1 is a diagram showing a configuration of an offline payment system according to an embodiment of the present disclosure.

FIG. 2 is a diagram showing a storage process of a control file according to the embodiment.

FIG. 3 is a diagram exemplarily showing a process of storing the control file according to the embodiment.

FIG. 4 is a diagram exemplarily showing an action attribute value according to the embodiment.

FIG. 5 is a diagram showing a scenario of a control file generation and compression process according to the embodiment.

FIG. 6 is a diagram showing a memory load process according to the embodiment.

FIG. 7 is a diagram exemplarily showing a memory log process according to the embodiment.

FIG. 8 is a diagram exemplarily showing control files of different versions according to the embodiment.

FIG. 9 is a diagram showing a process of payment medium approval processing according to the embodiment.

### DETAILED DESCRIPTION

Since the present disclosure may make various modifications and have various embodiments, specific embodiments will be illustrated in the drawings and described in detail in the detailed description. However, this is not to limit the present disclosure to specific exemplary embodiments, and it should be understood that the present disclosure covers all the modifications, equivalents and replacements included within the idea and technical scope of the present disclosure.

The terms used in the present specification are used only to describe specific embodiments, and are not intended to limit the present disclosure. A singular form includes a plural form unless the context clearly dictates otherwise. In this specification, it should be understood that term “include” or “have” is to indicate that a feature, a number, a step, an operation, a component, a part or the combination thereof described in the specification is present, but does not exclude a possibility of presence or addition of one or more other features, numbers, steps, operations, components, parts or combinations thereof, in advance.

In addition, the components of the embodiment described with reference to each drawing are not limitedly applied only to the corresponding embodiment, and may be implemented to be included in another embodiment within the scope of maintaining the technical idea of the present disclosure, and further, even if a separate explanation is omitted, it is natural that a plurality of embodiments may be re-implemented as one embodiment.

In addition, in the description with reference to the accompanying drawings, the same components are assigned the same or related reference numerals regardless of the reference numerals, and overlapping descriptions thereof will be omitted. In describing the present disclosure, a detailed description of related known technologies will be omitted if it is determined that they unnecessarily make the gist of the present disclosure obscure.

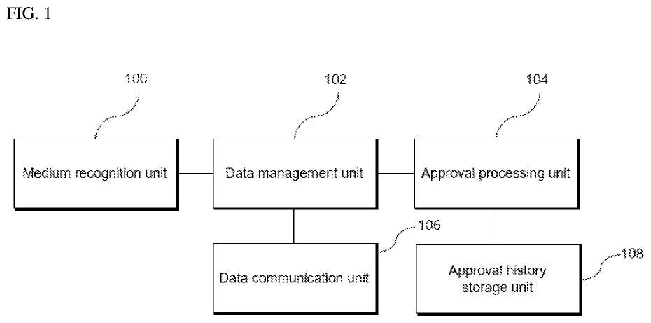

FIG. 1 is a diagram showing a configuration of an offline payment system according to an embodiment of the present disclosure.

As shown in FIG. 1, the offline payment system according to the embodiment may include a medium recognition unit 100, a data management unit 102, and an approval processing unit 104.

The medium recognition unit 100 recognizes a payment medium.

Here, the payment medium may also include a non-contact medium including an RFID, a barcode, or a QR code in addition to a credit card, a transportation card, a mobile card, and a mobile pay.

Such a payment medium may include a number for identifying a payment medium issuance company and a serial number for identifying the payment medium.

The offline payment system according to the embodiment may be connected to a payment medium issuance company server through a network, and receive and store payment medium related data from the payment medium issuance company server.

Here, the network may be a wired/wireless Internet in which security is maintained.

The data management unit 102 stores and manages a control file including whether multiple payment media are available in connection with the payment medium issuance company.

The control file is used for judging whether the recognized payment medium is available and whether the recognized payment medium is a discount application target, and the control file according to the embodiment is stored based on an active list.

Here, the active list is defined to judge whether the payment medium is available, and also the payment medium corresponds to an application target of a discount and various events unlike the black list.

The approval processing unit 104 processes whether to approve the recognized payment medium by referring to the control file stored in the data management unit 102.

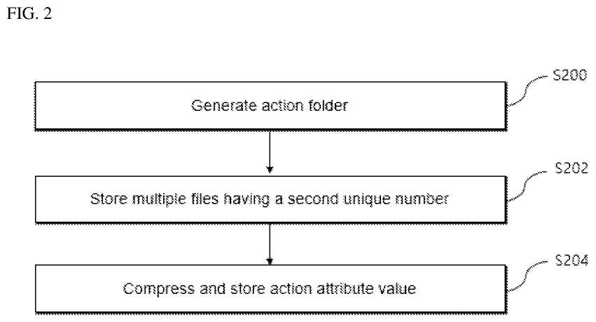

FIG. 2 is a diagram showing a storage process of a control file according to the embodiment.

Referring to FIG. 2, the data management unit 102 according to the embodiment generates multiple upper folders having different first unique numbers according to individual attributes including whether each of the multiple payment mediums is available, whether a concession discount is made, whether automatic charging is made, and whether an event discount is made (step 200).

The folder generated in step 200 as a folder for distinguishing the individual attributes is defined as an action folder in this specification.

In addition, whether the concession discount is made means whether a senior/old and weak preference discount is made and whether a student discount is made.

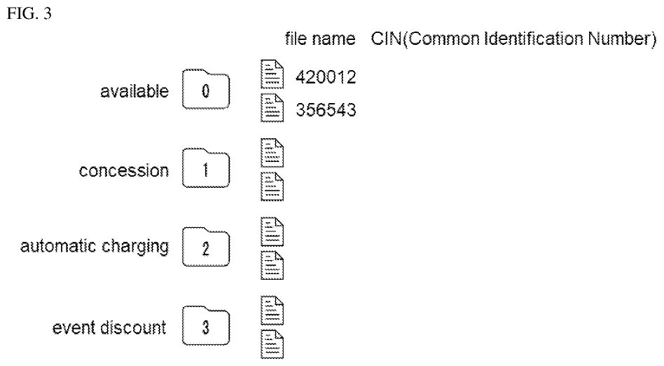

FIG. 3 is a diagram exemplarily showing a process of storing the control file according to the embodiment.

As shown in FIG. 3, the data management unit 102 generates the action folder in which first unique numbers such as 0 to 3 are granted to whether the payment medium is available, whether the concession discount is made, whether the automatic charging is made, and whether the event discount is made, respectively.

Next, the data management unit 102 stores multiple files having a second unique number capable of identifying an issuance company of each of the multiple payment media in each action folder (step 202).

In the embodiment, the second unique number may be defined as a common identification number (CIN) which is a common identifier, and in the case of a credit card or a check card, BIN may be granted, and in the case of a transportation card, CIN may be granted.

The second unique number may include a number capable of identifying a service partner and a charging/payment scheme in addition to the number for identifying only the payment medium issuance company.

Each file stores information for identifying an action attribute value for each of whether each of the multiple payment media is available, the concession discount is made, whether the automatic charging is made, and the discount is made, and the data management unit 102 compresses and stores the action attribute value (step 204).

In the embodiment, the action attribute value of each payment medium in the action file is defined as the active list.

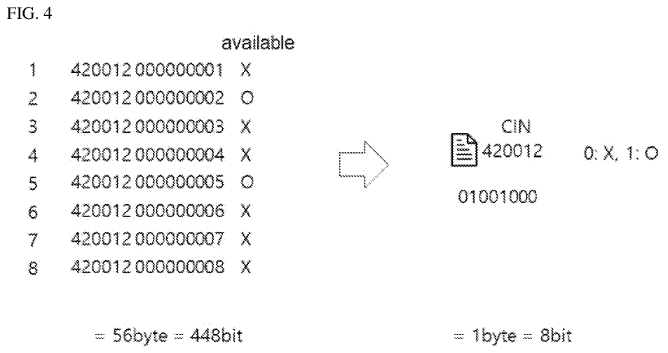

FIG. 4 is a diagram exemplarily showing an action attribute value according to the embodiment.

FIG. 4 exemplarily shows information in which a file name is stored as 420012 in an availability folder which is action folder #0.

Referring to FIG. 4, the data management unit 102 grants a bit for identifying whether multiple payment media issued by one payment medium issuance company are available in the order of a serial number by using a bitmap index technique.

In FIG. 4, when only payment media #2 and #5 among 8 payment media in which the first unique number is 420012 are used, 1 bit is granted to payment media #2 and #5 and 0 bit is granted to the remaining payment media to store 01001000 which is information capable of identifying whether 8 payment media are available in the 420012 file.

Therefore, information of 56 bytes is reduced by 1 bite (8 bits), so data storage efficiency is improved.

Furthermore, the data management unit 102 according to the present disclosure converts bits stored in each file into a text by using a binary-text conversion technique, and compresses and stores the converted text.

The binary-text conversion technique may include various techniques such as ASCII, UTF-16, and Base64, and the data management unit 102 converts multiple bits into one text by using the techniques.

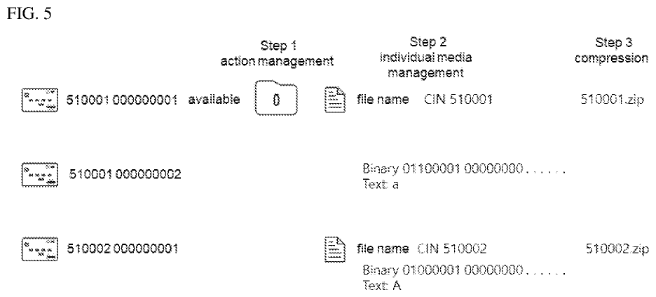

FIG. 5 is a diagram showing a scenario of a control file generation and compression process according to the embodiment.

Referring to FIG. 5, it is assumed that there are 3 users, and serial numbers of 2 users are #1 and #2 in CIN 510001, and a serial number of the remaining one is #1 in CIN 510002.

Among them, serial number #2 user of CIN 510001 loses the card and reports the loss of the card, and as a result, the card is to be controlled not to be used.

Files with names called 510001 and 51002 are generated below the action folder called user control 0.

In respect to the serial number of 510001, when a total of 999,999,999 bits (0: impossible and 1: used) have an action attribute value of 01100001 00000000 in the serial number order, if this is converted by a binary to text scheme, for example, the bits are converted into the text of a. The text is recorded in the 510001 file (16 bits are expressed as one letter).

Further, when the bits have the action attribute value of 01000001 00000000 in the serial number order of 510002, if the bits are converted by the binary to text scheme, for example, the bits are converted into a text of A.

When the file is completed, the file is compressed and a size of the file is minimized to generate 510001.zip and 510002.zip.

According to the embodiment, as described above, information on a large number of payment media is compressed and stored, and a search speed for whether to approve the card is enhanced.

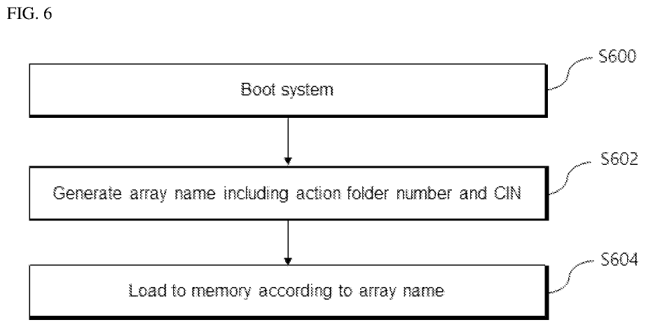

FIG. 6 is a diagram showing a memory load process according to the embodiment.

Referring to FIG. 6, when booting the offline payment system (step 600), array names including a first unique number and a second unique number according to individual attributes of the payment medium are generated (step 602), and loaded to the memory according to the array name (step 604).

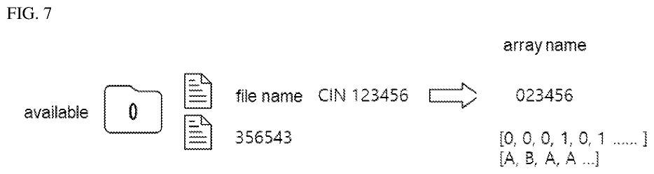

FIG. 7 is a diagram exemplarily showing a memory log process according to the embodiment.

Referring to FIG. 7, when a file stored in an action folder for use control is loaded to the memory, the number (first unique number, 0) of the action folder and CIN (second unique number, 123456) of the file are aggregated to generate an array name (0123456), which is loaded to the memory, so the search speed may be further increased when the memory is searched for approval processing.

Referring back to FIG. 1, the offline payment system according to the embodiment may include a data communication unit 106 which communicates with the server.

The data communication unit 106 continuously communicates with the payment medium issuance company server such as a bank or a card company to check a control state of the payment medium and store an updated control file in the data management unit 102.

According to the embodiment, the payment medium issuance company server may manage not only No. of the payment medium but also valid period information.

Here, the valid period information may be an action attribute value (whether the payment medium is available) of each of multiple payment media, and the server changes the action attribute value of each of multiple payment media by referring to a valid period, and transmits a control file including the changed action attribute value to the data communication unit 106.

According to the embodiment, while the control file is managed in different versions according to an update time by the payment medium issuance company, the control file may be constituted by multiple files of different versions.

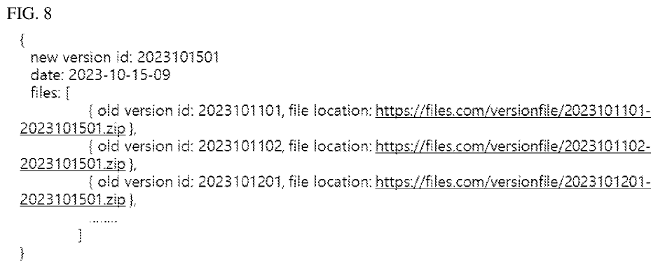

FIG. 8 is a diagram exemplarily showing control files of different versions according to the embodiment.

As shown in FIG. 8, the data communication unit 106 searches for a version of a control file currently stored, and searches for a version of a control file to be downloaded, and then receives a control file corresponding to the searched version from the server.

After the approval is completed by the approval processing unit 104, the offline payment system stores an approval history for the payment medium. In this case, a primary account number (PAN) of the payment medium is not directly stored, but should be hashed.

Referring back to FIG. 1, the offline payment system according to the embodiment includes an approval history storage unit 108 hashing and storing the PAN of the payment medium.

The approval history storage unit 108 converts a payment medium issuance company unique number of a recognized payment medium into a virtual number by using a matching table storing a virtual number of the payment medium issuance company, and stores a number acquired by hashing the converted virtual number and the remaining serial number of the payment medium as the hashed PAN of the payment medium.

There may be multiple matching tables having different unique numbers, and the approval history storage unit 108 selects one of the multiple matching tables, and converts the payment medium issuance company unique number into the virtual number through the selected matching table.

For example, when a payment medium having PAN of 510001 0110000100 is used, and CIN (payment medium issuance company unique number) of virtual number 5 is 510001 in a matching table having a unique number of 1F8X, the approval history storage unit downloads the matching table having the unique number of 1F8X by referring to the matching table of 1F8X, and hashes the remaining serial number to generate the hashed PAN.

The remaining serial number 0110000100 is hashed as follows.
82c24e545be1b3dd37a13fdbfb18f07b983ff3a68857f1568f2d9d11ac84df39

As such, when the card of 510001 0110000100 is used, UID 5 corresponding to CIN and serial-number 8-digit hashed PAN values are aggregated to complete encrypted medium number encryption by referring to the matching table having the unique number of 1F8X. Through this, an encryption level may be further increased.

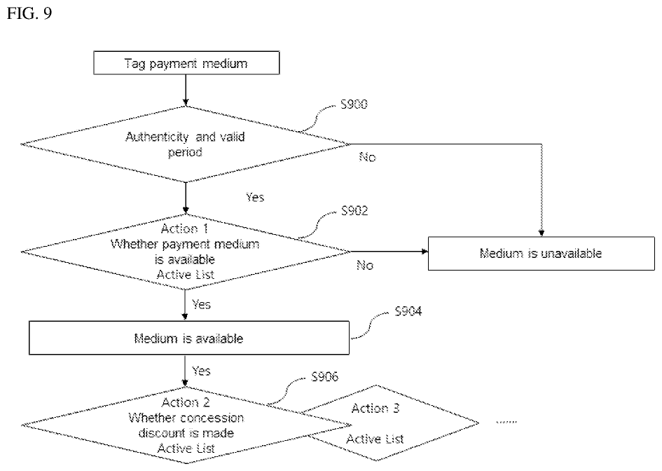

FIG. 9 is a diagram showing a process of payment medium approval processing according to the embodiment.

Referring to FIG. 9, when the payment medium is tagged by the offline payment system, the offline payment system judges an authenticity and a valid period of the payment medium (step 900), and when the payment medium is not forged, and the valid period remains, a control file (active list) stored in action folder 1 for the payment medium being available is checked to judge whether the payment medium is available (step 902).

When the payment medium is available through the active list (step 904), next action folders 1 and 2 are sequentially judged to check whether a concession discount is made, whether automatic charging is made, and whether an event discount is made, and complete approval processing (step 906).

The offline payment system according to the embodiment may be performed by a computing device including a processor and a program instruction storage unit.

Here, the processor may include a central processing unit (CPU) capable of executing a computer program or other virtual machines.

The program instruction storage unit may include a non-volatile storage device such as a fixed hard drive or a removable storage device. The removable storage device may include a compact flash unit, a USB memory stick, etc. The program instruction storage unit may also include a non-volatile memory such as various random access memories, and may be defined as a computer-readable recording medium.

The program instruction according to the embodiment performs payment medium recognition, control file management, approval processing, control file download, and approval history storage processes.

The embodiment of the present disclosure is disclosed for the purpose of the example, and it will be apparent to those skilled in the art that various modifications, changes, and additions may be made within the spirit and scope of the present disclosure and the modifications, changes, and additions should be considered as falling within the scope of the following claims.

What is claimed is:

1. An offline payment system comprising:
a medium recognition unit recognizing a payment medium;
a data management unit storing a control file including whether multiple payment media are available based on an active list in connection with a payment medium issuance company; and
an approval processing unit processing whether to approve the recognized payment medium by referring to the control file stored in the data management unit.

2. The offline payment system of claim 1, wherein the data management unit
generates multiple upper folders having different first unique numbers according to individual attributes including whether each of the multiple payment media is available, whether a concession discount is made, whether automatic charging is made, and whether an event discount is made, and
stores multiple files having a second unique number capable of identifying a payment medium issuance company in each of the multiple upper folders.

3. The offline payment system of claim 2, wherein the data management unit compresses and stores information for identifying an action attribute value for each of whether each of multiple payment media issued by a first payment medium issuance company is available, whether a concession discount is made, whether automatic charging is made, and whether a discount is made in each of the multiple files.

4. The offline payment system of claim 3, wherein the data management unit
grants bits for identifying the action attribute value in a predetermined serial number order of the multiple payment media issued by the first payment medium issuance company,
converts the granted bits into a text by using a binary-text conversion technique, and
compresses and stores the converted text.

5. The offline payment system of claim 4, wherein the data management unit converts bits corresponding to multiple bytes into one text by using ASCII, UTF-16, and Base64.

6. The offline payment system of claim 3, wherein when booting the offline payment system, an array name including a first unique number and the second unique number is generated and loaded to a memory.

7. The offline payment system of claim 3, wherein a valid period for the action attribute value for each of the multiple payment media is set, and a server connected through a network changes the action attribute value of each of the multiple payment media by referring to the valid period.

8. The offline payment system of claim 7, further comprising:
a data communication unit connected to the server through the network,
wherein the control file is generated for each of different versions according to a period, and
the data communication unit searches for a version of a control file currently stored, and a version of a control file to be downloaded, and then receives a control file corresponding to the searched version from the server.

9. The offline payment system of claim 1, further comprising:
an approval history storage unit hashing and storing number of the payment medium when approving the recognized payment medium.

10. The offline payment system of claim 9, wherein the approval history storage unit converts a payment medium issuance company unique number of the recognized payment medium into a virtual number by using one of multiple matching tables, and stores a number acquired by hashing the converted virtual number and the remaining serial number of the payment medium as a primary account number (PAN) of the payment medium.

11. A management method of an offline payment system, comprising:
storing a control file including whether multiple payment media are available based on an active list in connection with a payment medium issuance company;
recognizing a payment medium; and
processing whether to approve the recognized payment medium by referring to the stored control file.

12. A computer program stored in a non-transitory computer-readable storage medium performing the method of claim 11.
